(19) United States
(12) Patent Application Publication
(10) Pub. No.: US 2010/0184345 A1
(43) Pub. Date: Jul. 22, 2010

(54) GLASS YARNS SUITABLE FOR REINFORCING ORGANIC AND/OR INORGANIC MATERIALS

(75) Inventors: Jerome Lalande, Saint-Maur Des Fosses (FR); Anne Berthereau, Columbus, OH (US)

Correspondence Address: OBLON, SPIVAK, MCCLELLAND MAIER & NEUSTADT, L.L.P., 1940 DUKE STREET, ALEXANDRIA, VA, 22314, US

(73) Assignee: Saint-Gobain Technical Fabrics Europe, Chambery (FR)

(21) Appl. No.: 12/600,843

(22) PCT Filed: May 15, 2008
(86) PCT No.: PCT/FR08/50839

§ 371 Date: Mar. 23, 2010

(30) Foreign Application Priority Data
May 23, 2007 (FR) 0755218

(51) Int. Cl. B32B 5/02; C03C 13/00; C03C 13/02; C03C 3/087; C03C 3/097; C03C 3/112; C03C 3/091; C03C 14/00

(52) U.S. Cl. 442/1; 428/221; 501/35; 501/38; 501/70; 501/63; 501/71; 501/57; 501/66; 501/32

(57) ABSTRACT

The invention relates to reinforcing glass yarns of which the composition comprises the following components within the limits defined below expressed in weight percent:

| | |
|---|---|
| SiO₂ | 62-72% |
| Al₂O₃ | 4-11% |
| CaO | 8-22% |
| MgO | 1-7% |
| Na₂O + K₂O + Li₂O | 0-9% |
| BaO + SrO | 0-4% |
| B₂O₃ | 0-4% |
| F₂ | 0-2% |
| Other components: TiO₂ + ZrO₂ + | 0-4% |
| Fe₂O₃ (total iron) + P₂O₅ + MnO + Cr₂O₃ + | |
| MoO₃ + ZnO + SO₃ | |

These yarns consist of an economical glass offering an excellent comprise between its mechanical properties represented by the specific Young's modulus and its drawing conditions.

The invention also relates to the glass composition suitable for manufacturing said glass yarns, the basic structures of such yarns, in particular meshes, fabrics and mats, and the composites incorporating such yarns.

The invention relates to glass yarns suitable for reinforcing organic and/or inorganic materials. It also relates to the glass composition suitable for manufacturing such glass yarns and the composites based on such materials reinforced by said yarns.

The field of reinforcing glass yarns is a very particular field of the glass industry. These yarns are obtained by the method that consists in mechanically drawing threads of molten glass flowing through orifices arranged at the base of a die generally heated by Joule effect.

The yarns are produced from specific glass compositions for obtaining filaments having a diameter of a few microns and for the formation of continuous yarns suitable for performing the reinforcing function in organic and/or inorganic materials in order to impart better mechanical properties thereto. The reinforcing glass yarns are used as such or in the form of organized assemblies such as fabrics.

The mechanical properties of these reinforced materials are mainly governed by the composition of the glass constituting the reinforcing yarns. The most commonly known glasses for this use are “E” type glasses having the composition SiO₂—Al₂O₃—CaO of which the archetype is described in patents U.S. Pat. No. 2,334,981 and U.S. Pat. No. 2,571,074 and which have a composition essentially based on silica, alumina, lime and boric anhydride. The latter component, present in a content of between 5 and 13%, is added to replace silica, and it serves to draw the E glass under highly advantageous conditions, particularly with a relatively low working temperature, of about 1200° C., a liquidus temperature about 120° C. lower than the working temperature, and a low devitrification rate.

In the context of the present invention, “working temperature” means the temperature at which the glass has a viscosity of 1000 poises (denoted T_{log3}). In the context of the present invention, “liquidus temperature” (denoted T_{liq}) means the temperature at which the most refractory phase, which may devitrify in the glass, has a zero growth and thus corresponds to the melting point of this devitrified phase. The liquidus temperature gives the lower temperature limit at which the glass can be drawn.

The “drawing range”, denoted ΔT, which corresponds to the difference between the working temperature and the liquidus temperature, is a criterion for measuring the aptitude of a molten glass composition to crystallize. In general, the risk of devitrification during the drawing of the filaments is avoided when the drawing range ΔT is positive, preferably above 50° C.

The composition of E glass defined in standard ASTM D 578-98 is the following (in weight percent): 52 to 56% SiO₂; 12 to 16% Al₂O₃; 16 to 25% CaO; 5 to 10% B₂O₃; 0 to 5% MgO; 0 to 2% Na₂O+K₂O; 0 to 0.8% TiO₂; 0.05 to 0.4% Fe₂O₃; 0 to 1% F₂.

Boric anhydride B₂O₃, and fluorine F₂, play the role of a flux in the glass batch, which, as already mentioned, and thereby allow the glass to be drawn under better conditions. However, these components have the drawback of being volatile and of generating emissions of boron and fluorine which must necessarily be treated in pollution control installations before being released into the atmosphere. The implementation of this treatment incurs a high extra cost of the glass yarns. Furthermore, the raw materials from which these components are obtained, in particular B₂O₃, which must account for at least 5% by weight of the glass, are relatively expensive.

Standard ASTM D 578-98 provides for other reinforcing yarns of E glass which may not contain boron. These yarns have the following composition (in weight percent): 52 to 62% SiO₂; 12 to 16% Al₂O₃; 16 to 25% CaO; 0 to 10% B₂O₃; 0 to 5% MgO; 0 to 2% Na₂O+K₂O; 0 to 1.5% TiO₂; 0.05 to 0.8% Fe₂O₃; 0 to 1% F₂.

Numerous particular glass compositions meeting the latter standard have been proposed.

Thus, U.S. Pat. No. 3,847,626 describes a glass composition in which B₂O₃ and F₂ are replaced by high contents of TiO₂ (3 to 5%) and of MgO (1.5 to 4%). Although the two oxides serve to compensate for the absence of boron and fluorine while allowing the drawing, on the other hand, the glass formed has a yellow color due to the TiO₂, which tends to make it unfit for certain applications. A high TiO₂ content (2 to 4%) is also recommended in U.S. Pat. No. 4,026,715, combined with divalent oxides such as SrO, ZnO or BaO, which nevertheless have the drawback of being expensive.

U.S. Pat. No. 4,199,364 describes compositions comprising a high lithium oxide content. Apart from its high cost, this compound forms part of the alkali oxides known to degrade the fitness of the fibers for the reinforcement of electronic circuit supports.

Application WO 96/39362 describes compositions without boron, and possibly without fluorine, formed essentially from the quaternary system SiO₂—Al₂O₃—CaO—MgO, containing a small quantity of TiO₂ (less than 0.9%) and generally free of costly oxides such as those described in the abovementioned applications. The liquidus temperature and the working temperature of these glasses are nevertheless relatively high.

More recently, several attempts have been made to obtain low cost glasses whose drawing conditions approach those of E glass containing boron.

Thus, WO 99/12858 and WO 99/01393 describe glass compositions containing small quantities of B₂O₃ or F₂.

In WO 00/73232, the drop in the characteristic temperatures is obtained thanks to glass compositions combining a low MgO content (less than 1%) and the addition of a certain quantity of boron oxide, lithium oxide, zinc oxide, or manganese oxide, thereby reducing the economic advantage of these compositions. In WO 00/73231, the liquidus temperature is lowered, in particular thanks to the addition of MgO in a narrow proportion, between 1.7 and 2.6%, which in most of the compositions exemplified is combined with an oxide selected from boron oxide, lithium oxide, zinc oxide and manganese oxide.

A decrease in the characteristic drawing temperatures is also obtained, in WO 01/32576, by a glass composition containing a low silica content (less than 58%), and in US 2003/0224922 by the selection of glass compositions having a weight ratio of silica to the sum of alkaline-earth oxides that is lower than 2.35.

It is found that the producers of yarns of E glass according to the abovementioned ASTM standard D 578-98 have had the constant concern of lowering the cost of the glass composition by decreasing the content of the most expensive components, which are boron and fluorine, while preserving a good aptitude of the glass for drawing, a low level of pollutant emissions, and properties compatible with use as reinforcement of organic and/or inorganic materials.

It is an object of the present invention to provide yarns consisting of a glass having a different composition from that of E glass, which have a level of performance, particularly in terms of mechanical properties and hydrolytic resistance, comparable to E glass, at a lower cost.

This object is achieved according to the invention thanks to the glass yarns having a lower alumina content, of which the composition comprises the following components within the limits defined below expressed in weight percent:

| | |
|---|---|
| SiO₂ | 62-72% |
| Al₂O₃ | 4-11% |
| CaO | 8-22% |
| MgO | 1-7% |
| Na₂O + K₂O + Li₂O | 0-9% |
| BaO + SrO | 0-4% |
| B₂O₃ | 0-4% |
| F₂ | 0-2% |
| Other components: TiO₂ + ZrO₂ + | 0-4% |
| Fe₂O₃ (total iron) + P₂O₅ + MnO + Cr₂O₃ + | |
| MoO₃ + ZnO + SO₃ | |

Silica SiO₂ is one of the oxides forming the glass lattice according to the invention and plays an essential role for their stability. In the context of the invention, when the silica content is lower than 62%, the glass obtained is not viscous enough and devitrifies too easily during the drawing. Above 72%, the glass becomes highly viscous and difficult to melt. Preferably, the silica content is between 63 and 71%.

Alumina Al₂O₃ also constitutes one of the oxides forming the glass lattice according to the invention and plays an essential role with regard to stability. The alumina content is limited to 11%, preferably 10%, essentially to reduce the final cost of the glass. An alumina content lower than 4% causes a significant increase in hydrolytic attack of the glass and a decrease in the Young's modulus of the glass. Preferably, the alumina content is equal to or higher than 6%, and even better equal to or higher than 7%.

Advantageously, the sum of the silica and alumina contents is above 72%, preferably above 73%, which serves to obtain advantageous values of hydrolytic resistance. Preferably, the sum of the silica and alumina contents is equal to or lower than 77%.

The CaO content serves to adjust the viscosity and to control the devitrification of the glasses. In the context of the limits defined according to the invention, a CaO content above 22% increases the rate of devitrification to Ca.SiO₃ (wollastonite) which is detrimental to good drawing. A content lower than 8% unacceptably decreases the hydrolytic resistance of the glass. Preferably, the CaO content is equal to or higher than 12%, and advantageously lower than 19%.

Magnesia MgO, in combination with CaO, serves to lower the liquidus temperature of the glass. The addition of MgO in the content indicated serves to introduce a competition between the growth of the wollastonite crystals and the growth of the dioxide crystals (CaO.MgO.2SiO₂), having the effect of slowing the growth of these two types of crystals and finally imparting better devitrification resistance to the glass. Furthermore, MgO contributes to obtaining a high hydrolytic resistance. The MgO content varies between 1 and 7%, preferably between 3 and 5%.

BaO and SrO may be present in the glass composition in a total content lower than 4%, preferably lower than 2%, to avoid increasing the cost and density of the glass (which has the effect of lowering the specific Young's modulus). In general, the composition contains no BaO or SrO.

The alkali oxides, Na₂O, K₂O and Li₂O, may be introduced into the composition according to the invention to contribute to limit the devitrification and reduce the viscosity of the glass. The alkali oxide content must nevertheless remain lower than or equal to 9% to avoid degrading the hydrolytic resistance of the glass and to maintain the mechanical properties of the yarn at an acceptable level. The alkali oxide content is preferably lower than 7%, and in particular higher than 1%.

According to a first embodiment, the Na₂O content is equal to or higher than 3%, preferably lower than or equal to 7% and even better lower than 6%, the K₂O content is lower than or equal to 1%, preferably lower than or equal to 0.5% and even better lower than or equal to 0.3%, and the Li₂O content is lower than 1% and preferably zero.

According to a second embodiment, the Na₂O content varies between 2 and 4%, and is preferably about 3%, the K₂O content also varies within the same limits, and the Li₂O content is lower than 1% and preferably zero.

Boron oxide B₂O₃ plays a role of fluidizer. Its content in the glass composition according to the invention is limited to 4%, preferably lower than or equal to 2%, to avoid problems of volatilization and pollutant emission, and to avoid significantly increasing the cost of the composition. The boron may be incorporated as a raw material in the form of glass yarn waste containing boron, in particular E glass. In general, the compositions according to the invention contain no B₂O₃.

Fluorine may be added in small quantities to improve the melting of the glass, or may be present as an impurity issuing from the vitrifiable raw materials, but without exceeding 2%. Preferably, the fluorine content is lower than 1% because a higher level may incur risks of pollutant emissions and corrosion of the furnace refractories. In general, the compositions according to the invention contain no fluorine.

The components TiO₂, ZrO₂, Fe₂O₃ (total iron), P₂O₅, MnO, Cr₂O₃, MoO₃, ZnO and SO₃ may be present in the glass composition in a total content of not more than 4%, preferably not more than 2%.

Preferably, these components are present in the following contents:

| TiO₂ | 0-2%, in particular 0-1% |
|---|---|
| ZrO₂ | 0-2%, in particular 0-1% |
| Fe₂O₃ (total iron) | 0-1%, in particular 0-0.5% |
| P₂O₅ | 0-2% |
| MnO | 0-0.5% |
| Cr₂O₃ | 0-0.5% |
| MoO₃ | 0-0.5% |
| ZnO | 0-2 |
| SO₃ | 0-1% |

The glass yarns according to the invention are obtained from the glass composition previously described according to the following method: a multiplicity of threads of molten glass are drawn, in the form of one or more sheets of continuous yarns, the filaments are gathered into one or more yarns which are collected on a moving support. This may be a rotating support when the yarns are collected in the form of windings or a translational support when the yarns are cut by a member also serving to draw them or when the yarns are projected by a member serving to draw them in such a way as to form a mat.

The yarns obtained generally comprise filaments having a diameter of 5 to 30 microns, and their linear density may vary to a large extent.

These yarns may undergo processing operations, for example in order to “bulk” them, to impart a twist or to join them to form yarns having an even higher linear density. The yarns may thus be in different forms: continuous or cut yarns, meshes, fabrics, knits, braids, ribbons or mats. Preferably, the yarns are joined in structures having the shape of meshes, fabrics and mats.

The yarns having a filament diameter lower than or equal to 11 microns and a linear density lower than or equal to 200 Tex are suitable more particularly for textile applications. These yarns are advantageously twisted and/or stranded and coated with a specific size enabling them to withstand weaving operations.

Yarns having higher diameter and linear density, preferably without twist, are more particularly suitable for reinforcing plastics.

The glass melt supplied to the dies is obtained from pure raw materials (for example from the chemical industry) or more generally from natural materials (the latter sometimes containing trace impurities), these raw materials being mixed in suitable proportions to obtain the desired composition, and then being melted. The glass melt temperature (and therefore its viscosity) is conventionally adjusted in order to permit drawing while avoiding problems of devitrification. Before being joined in the form of yarns, the filaments are generally coated with a size composition designed to protect them from abrasion and facilitate their subsequent combination with the materials to be reinforced.

Optionally, the glass yarns according to the invention may be combined with organic filaments, for example during drawing, to form composite yarns.

The composites obtained from the yarns according to the invention comprise at least one organic material and/or at least one inorganic material and glass yarns, at least part of the yarns being yarns according to the invention. These composites have good mechanical properties and hydrolytic resistance.

The following examples serve to illustrate the invention but without limiting it.

a) Production of Bulk Glasses

Glasses are prepared having the composition appearing in Table 1, expressed in weight percent.

Examples 1 to 9 illustrate the glasses according to the invention; examples C1 and C2 are comparative examples: C1 is a boron-free glass described in application WO-A-96/39362 and C2 is a standard E glass containing boron.

Table 1 shows the following:
the working temperature T_{log3} corresponding to the temperature at which the viscosity of the glass is equal to 10³ poises,
the liquidus temperature T_{liqu} corresponding to the temperature at which the most refractory phase, which can devitrify in the glass, has a zero growth rate and thereby corresponds to the melting point of this devitrified phase,)
the drawing range ΔT corresponds to the difference in temperatures between T_{log3} and T_{liq},
the Littleton point T_{log7.6} corresponding to this temperature at which the viscosity of the glass is equal to 10^{7.6} poises. This temperature is an indicator for estimating the fire resistance of the glass, and hence of the composites containing same,
the value of the specific Young's modulus of the bulk glass which corresponds to the ratio of the Young's modulus measured according to standard ASTM C 1259-01 and the density of the glass sample measured by the Archimedes method. A good correlation exists between the specific Young's modulus measured on the mass glass and the specific Young's modulus of the yarn comprising filaments of the same glass; in consequence, the values in Table 1 provide an estimate of the mechanical properties in terms of modulus of the glass after drawing,
the hydrolytic resistance, evaluated by the “DGG” method (Deutsche Glastechniche Gesellschaft after Fisher and Fischer and Tepoel; Glastech. Ber.; vol. VI, p. 522; 1928) which consists in measuring the attack of the glass by water. For this purpose, 10 g of ground glass (grain size 360-400 μm) is immersed in 100 ml of water and 98° C. for five hours. After rapid cooling, the solution is filtered. The mass of dry residue is measured on the filtrate, expressed as mg/10 g of glass and the alkalinity corresponding to the mass of alkali is determined by titration with hydrochloric acid, expressed in mg equivalent Na₂O/10 g of glass.

It appears that the examples according to the invention offer an excellent compromise between the melting and drawing properties, the mechanical properties and the hydrolytic resistance.

In the examples according to the invention, the working temperature remains acceptable even though it is higher than the examples C1 and C2, and the drawing range is at least equal to about 50° C., and may be up to 93° C. (example 1).

The specific Young's modulus of the examples according to the invention, in particular example 4, is substantially equivalent to that of the examples C1 and C2.

The hydrolytic resistance of examples 1 and 8 is comparable to that of examples C1 and C2, and that of example 9 is better.

The glasses of examples 4 to 6 have a Littleton point higher than that of E glass with boron (example C2), and in consequence better fire resistance.

b) Production of Glass Yarns

Glass yarns (filament diameter: 17 μm; linear density: 235 Tex) are obtained in a conventional drawing installation from the glasses of examples 4, 7 and C2.

The unit tensile strength, measured in the conditions of standard ISO 3341, is given in Table 2 below.

TABLE 2

| | Unit tensile strength |
|---|---|
| Example | (cN/Tex) |
| 7 | 0.40 |
| 4 | 0.45 |
| C2 | 0.45 |

The breakage rate of yarns obtained from the glasses of examples 4 and 7 according to the invention is similar to that of the glass yarns of example C2.

TABLE 1

| | Ex. 1 | Ex. 2 | Ex. 3 | Ex. 4 | Ex. 5 | Ex. 6 | Ex. 7 | Ex. 8 | Ex. 9 | C1 | C2 |
|---|---|---|---|---|---|---|---|---|---|---|---|
| SiO₂(%) | 71.50 | 70.10 | 70.50 | 64.30 | 65.00 | 64.90 | 64.30 | 64.20 | 64.90 | 60.90 | 54.10 |
| Al₂O₃ (%) | 7.00 | 6.10 | 6.30 | 9.60 | 9.00 | 9.10 | 9.00 | 8.10 | 9.40 | 12.70 | 14.70 |
| CaO (%) | 10.40 | 12.80 | 14.00 | 17.20 | 16.50 | 16.70 | 16.50 | 16.90 | 16.80 | 22.00 | 22.20 |
| MgO (%) | 6.10 | 5.00 | 4.90 | 3.50 | 3.50 | 3.30 | 3.80 | 3.60 | 3.40 | 3.00 | 0.30 |
| Na₂O (%) | 4.60 | 5.60 | 3.90 | 4.80 | 3.10 | 3.30 | 3.00 | 3.80 | 4.90 | 0.30 | 0.50 |
| K₂O (%) | 0.20 | 0.20 | 0.20 | 0.30 | 2.70 | 2.30 | 3.10 | 2.30 | 0.30 | 0.40 | 0.30 |
| B₂O₃(%) | — | — | — | — | — | — | — | — | — | — | 7.30 |
| Fe₂O₃(%) | 0.13 | 0.12 | 0.11 | 0.15 | — | 0.15 | 0.20 | 0.90 | 0.14 | 0.30 | — |
| Other⁽*⁾ | 0.13 | 0.08 | 0.09 | 0.20 | 0.20 | 0.20 | 0.10 | 0.34 | 0.24 | 0.50 | 0.60 |
| T_{log3} (° C.) | 1363 | 1316 | 1309 | 1279 | 1290 | 1311 | 1288 | 1299 | 1288 | 1268 | 1203 |
| T_{liq} (° C.) | 1270 | 1250 | 1260 | 1220 | 1230 | 1220 | 1230 | 1230 | 1220 | 1180 | 1080 |
| ΔT (° C.) | 93 | 66 | 49 | 59 | 60 | 91 | 58 | 69 | 68 | 88 | 123 |
| T_{log7.6} (° C.) | n.d. | n.d. | n.d. | 865 | 876 | 876 | n.d. | n.d. | n.d. | 920 | 840 |
| Specific Young's modulus | 32.8 | 31.9 | 32.2 | 33.3 | 32.1 | 32.2 | 32.1 | 31.8 | 32.3 | 33.2 | 33.3 |
| (MPa/kg/m³) | | | | | | | | | | | |
| Density (g/cm³) | 2.51 | 2.52 | 2.51 | 2.57 | 2.57 | 2.55 | 2.56 | 2.58 | 2.58 | 2.66 | 2.62 |
| Hydrolytic resistance | | | | | | | | | | | |
| Residue (mg/10 g) | 8.3 | 9.0 | 10.8 | 10.2 | 10.4 | 8.4 | 8.1 | 7.9 | 6.7 | 8.4 | 7.0 |
| Alkalinity (mg equivalent | 1.9 | 2.2 | 2.8 | 1.8 | 2.0 | 1.6 | 2.0 | 2.2 | 1.7 | 1.6 | n.d. |
| Na₂O/10 g) | | | | | | | | | | | |

n.d.: not determined
⁽*⁾(TiO₂, ZrO₂, P₂O₅, MnO, Cr₂O₃, MoO₃, SO₃)

1. A reinforcing glass yarn of which the composition comprises the following components within the limits defined below expressed in weight percent:

| | |
|---|---|
| SiO₂ | 62-72% |
| Al₂O₃ | 4-11% |
| CaO | 8-22% |
| MgO | 1-7% |
| Na₂O + K₂O + Li₂O | 0-9% |
| BaO + SrO | 0-4% |
| B₂O₃ | 0-4% |
| F₂ | 0-2% |
| [[Other]] and other components: TiO₂ + ZrO₂ + | 0-4% |
| Fe₂O₃ (total iron) + P₂O₅ + MnO + Cr₂O₃ + | |
| MoO₃ + ZnO + SO₃ | |

2. The glass yarn as claimed in claim 1, wherein the SiO₂ content is between 63 and 71%.

3. The glass yarn as claimed in claim 1, wherein the Al₂O₃ content is equal to or higher than 6%.

4. The glass yarn as claimed in claim 1, wherein the sum of the SiO₂ and Al₂O₃ contents is higher than 72%.

5. The glass yarn as claimed in claim 1, wherein the CaO content is equal to or higher than 12%.

6. The glass yarn as claimed in claim 1, wherein the MgO content varies between 3 and 5%.

7. The glass yarn as claimed in claim 1, wherein the alkali oxide content is lower 9%.

8. The glass yarn as claimed in claim 1, wherein the Na₂O content is equal to or higher than 3%, the K₂O content is equal to or lower 1% and the Li₂O content is lower than 1%.

9. The glass yarn as claimed in claim 1, wherein the Na₂O content and the K₂O content vary between 2 and 4%, and the Li₂O is lower than 1%.

10. The glass yarn as claimed in claim 1, wherein the B₂O₃ does not exceed 2%.

11. A glass composition suitable for manufacturing reinforcing glass yarns as claimed in claim 1, which comprises the following components:

| | |
|---|---|
| SiO₂ | 62-72% |
| Al₂O₃ | 4-11% |
| CaO | 8-22% |
| MgO | 1-7% |
| Na₂O + K₂O + Li₂O | 0-9% |
| BaO + SrO | 0-4% |
| B₂O₃ | 0-4% |
| F₂ | 0-2% |
| [[Other]] and other components: TiO₂ + ZrO₂ + | 0-4% |
| Fe₂O₃ (total iron) + P₂O₅ + MnO + Cr₂O₃ + | |
| MoO₃ + ZnO + SO₃ | |

12. The glass composition as claimed in claim 11, wherein it has a drawing range ΔT at least equal to about 50° C.

13. A mat, mesh or fabric structure comprising reinforcing glass yarns, wherein said structure comprises glass yarns as defined by claim 1.

14. A composite of glass yarns and organic and/or inorganic material(s), wherein said composite comprises glass yarns as defined by claim 1.
